(19) United States
(12) Patent Application Publication
(10) Pub. No.: US 2003/0041951 A1
(43) Pub. Date: Mar. 6, 2003

(54) Electronic dartboard block fabrication method

(76) Inventor: Yuh-Shiang Huang, Taichung (TW)

Correspondence Address: Keith Kline, PRO-TECHTOR INTERNATIONAL SERVICES, 20775 Norada Court, Saratoga, CA, 95070-3018, US

(21) Appl. No.: 09/944,943

(22) Filed: Sep. 1, 2001

(51) Int. Cl. B32B 31/00; B29C 47/00

(52) U.S. Cl. 156/153; 156/245; 156/242

(57) ABSTRACT

An electronic dartboard block fabrication method includes the step of material preparation to prepare pieces of hem blocks, the step of shape molding to mold hem blocks into shaped blocks, the step of container preparation to prepare containers, the step of container setting to press-fit shaped blocks into the prepared containers, the step of grinding to grind the surface of the shaped block in each container, and the step of finishing to color the surface of the shaped block in each container.

### BACKGROUND OF THE INVENTION

The present invention relates to electronic dartboards and, more particularly, to a method of fabricating dartboard blocks for making electronic dartboards, which greatly improves the quality of electronic dartboards and reduces their manufacturing cost.

Conventional dartboards are commonly made by compacting hem fibers into a disk, and then dividing the hem disk into different zones, and then coloring the divided zones with different colors for different scores. A dartboard made according to this method is functional in use. However, it is not easy to count the score by man accurately. This counting method cannot eliminate human error absolute. In order to prevent this problem, electronic dartboards are developed. Regular electronic dartboards and the darts for electronic dartboards are commonly made of plastic material. It is more difficult to insert a plastic dart into a plastic electronic dartboard by throwing. Furthermore, these conventional plastic electronic dartboards are not allowed for official games.

### SUMMARY OF THE INVENTION

The present invention has been accomplished to provide an electronic dartboard, which eliminates the aforesaid drawbacks. According to the present invention, an electronic dartboard block is made by: molding hem fibers into a shaped hem block and then press-fitting the shaped hem block into a container prepared subject to a predetermined pattern to form with the container an electronic dartboard block.

The electronic dartboard block fabrication method of the invention includes the step of material preparation to prepare pieces of hem blocks, the step of shape molding to mold hem blocks into shaped blocks, the step of container preparation to prepare containers, the step of container setting to press-fit shaped blocks into the prepared containers, the step of grinding to grind the surface of the shaped block in each container, and the step of finishing to color the surface of the shaped block in each container.

### BRIEF DESCRIPTION OF THE DRAWINGS

FIG. 1 is an electronic dartboard block fabrication flow chart of the present invention.

FIG. 2 illustrates the step of material preparation according to the present invention.

FIG. 3 illustrates the step of shape molding according to the present invention.

FIG. 4 illustrates the step of container setting according to the present invention.

FIG. 5 illustrates different patterned of electronic dartboard blocks made according to the present invention.

### DETAILED DESCRIPTION OF THE PREFERRED EMBODIMENT

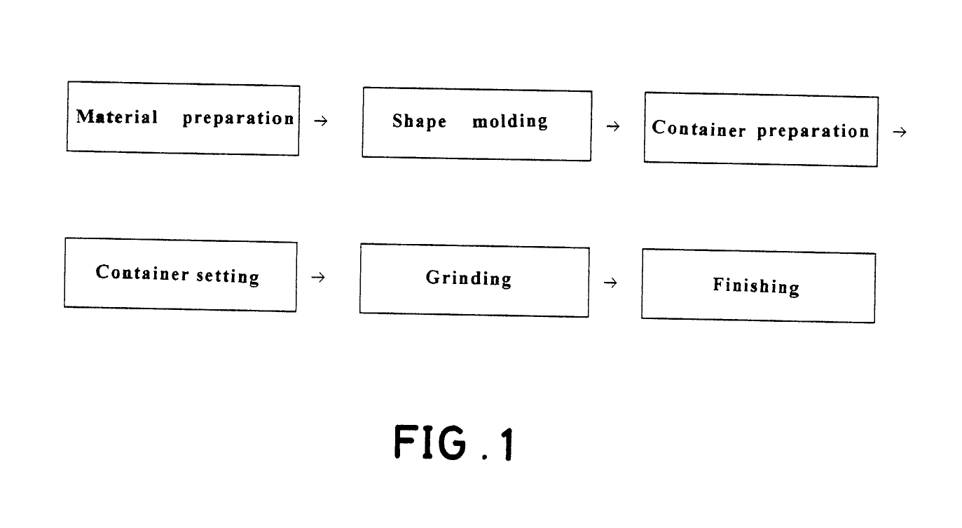

Referring to FIGS. 1-3, the electronic dartboard block fabrication method of the present invention comprises the steps of:

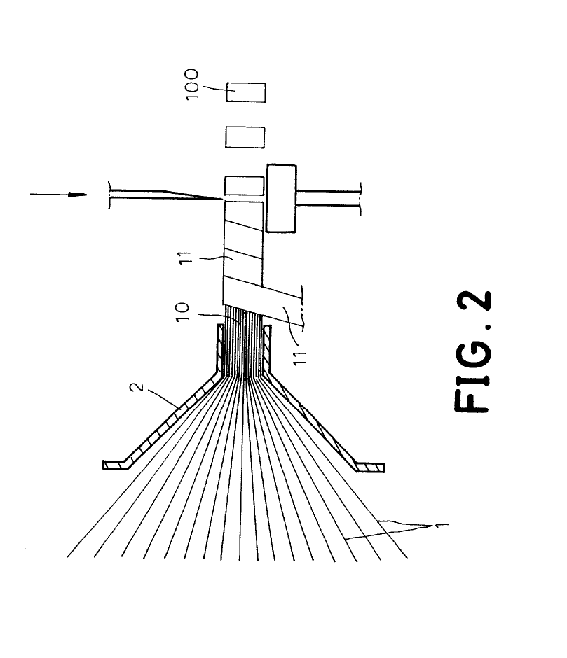

1. Material preparation where hemp fibers 1 are compacted into a cord of hemp 10 through a hemp compacting machine 2, and the cord of hemp 10 thus obtained is then wrapped with an adhesive tape 11 and then cut into pieces of hemp blocks 100 (see FIG. 2);

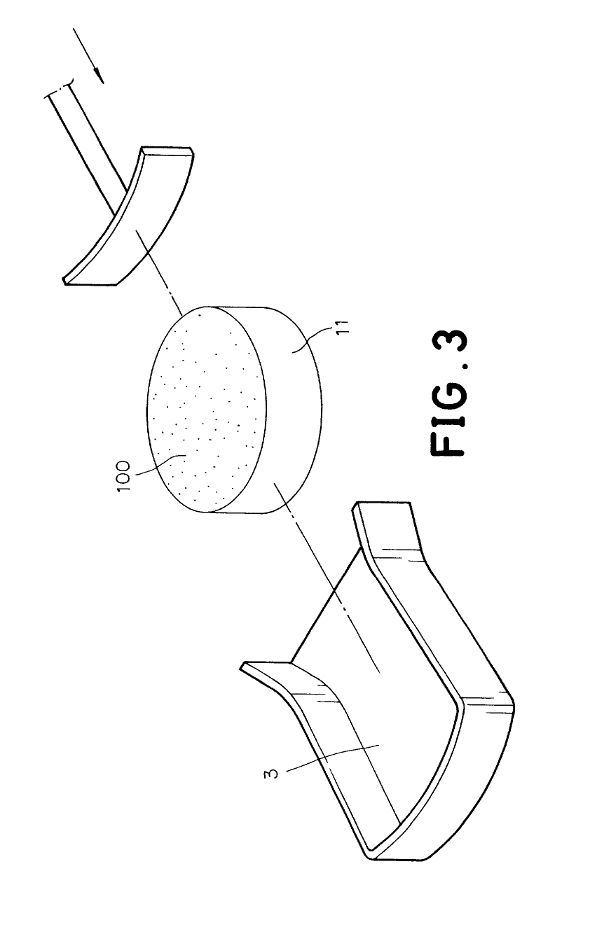

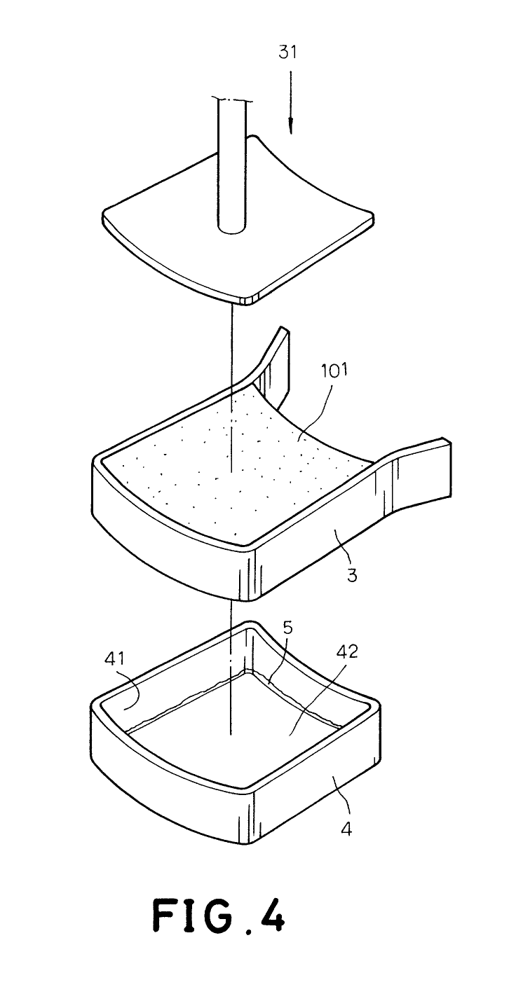

2. Shape molding where the hemp blocks 100 are respectively put in respective molds 3, and then squeezed in the respective molds 3, forming respective shaped blocks 101 (see FIGS. 3 and 4);

3. Container preparation where different containers 4 are prepared subject to the shapes of the shaped blocks 101, and a glue 5 is applied to the inner surface of the upright peripheral wall 41 and inner surface of the horizontal bottom wall 42 of each of the containers 4;

4. Container setting where the shaped blocks 101 are respectively press-fitted into the containers 4; a plunger 31 is operated to compact the shaped block 101 in each container 4, causing each shaped block 101 to be positively adhered to the inside wall of the respective container 4; and then the glue 5 in each container 4 is dried at room temperature or by baking;

5. Grinding where a grinder is operated to grind the surface of the shaped block 101 in each container 4; and

6. Finishing where the ground surface of the shaped block 101 in each container 4 is colored with a particular color subject to its position in the whole dartboard.

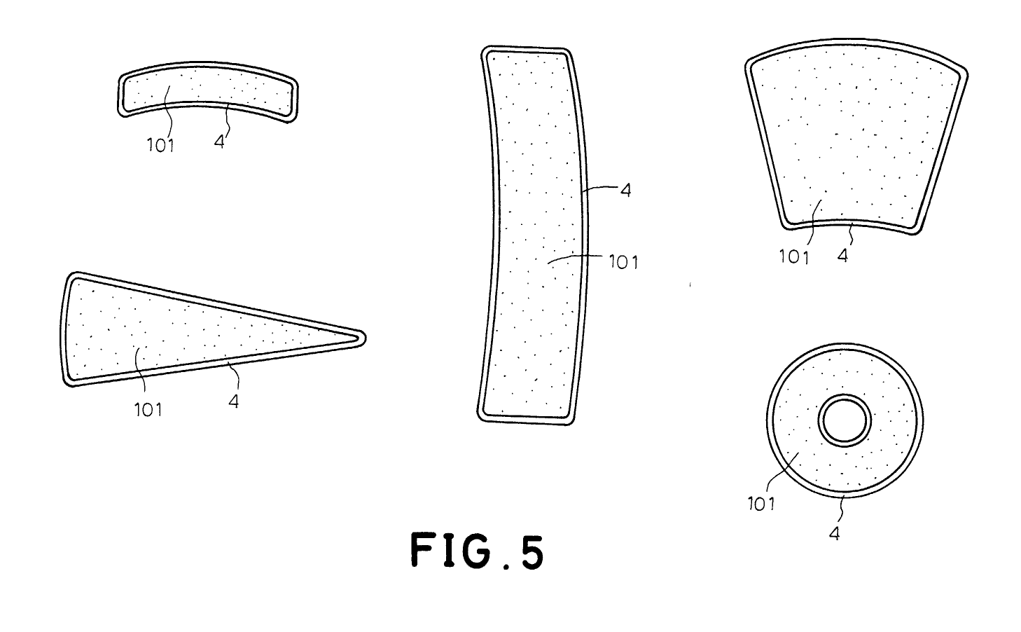

FIG. 5 shows different shapes of electronic dartboard blocks made according to the present invention and adapted to be positioned in different areas in an electronic dartboard for different scores. As illustrated, each electronic dartboard block is comprised of a container 4 and a shaped block 101 fixedly mounted inside the container 4.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electronic dartboard block fabrication method comprising the step of molding hem fibers into a shaped hem block and the step of press-fitting said shaped hem block into a container prepared subject to a predetermined pattern to form with said container an electronic dartboard block.

2. The electronic dartboard block fabrication method as claimed in claim 1 wherein said container has an inside wall covered with a layer of glue before the insertion of said shaped hem block into said container.

3. An electronic dartboard block fabrication method comprising the steps of:
a) Material preparation where hemp fibers are compacted into a cord of hemp through a hemp compacting machine, and the cord of hemp thus obtained is then wrapped with an adhesive tape and then cut into pieces of hemp blocks;
b) Shape molding where the hemp blocks thus obtained are respectively put in molds, and then squeezed in the respective molds, forming respective shaped blocks;
c) Container preparation where different containers are prepared subject to predetermined patterns, and a glue is applied to the inside wall of each of said containers;
d) Container setting where said shaped blocks are respectively press-fitted into said containers, and a plunger is operated to compact said shaped blocks in said containers respective, causing said shaped blocks to be positively respectively adhered to said containers;
e) Grinding where a grinder is operated to grind the surface of the shaped block in each of said containers; and
f) Finishing where the ground surface of the shaped block in each of said containers is respectively colored with a respective color.

4. The electronic dartboard block fabrication method as claimed in claim 3 wherein said glue is dried by baking after the operation of said plunger to compact said shaped blocks in said containers during the step of container setting.

5. The electronic dartboard block fabrication method as claimed in claim 3 wherein said glue is dried in the open air after the operation of said plunger to compact said shaped blocks in said containers during the step of container setting.
